(19) United States
(12) Patent Application Publication
(10) Pub. No.: US 2006/0289565 A1
(43) Pub. Date: Dec. 28, 2006

(54) Product dispensing package with single use thermal engine

(76) Inventors: Stephen Manzo, Marlton, NJ (US); Joseph Giglio, East Windsor, NJ (US); Manoj K. Patel, Piscataway, NJ (US); James Michael Robinson SR., Somerset, NJ (US)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 11/454,962

(22) Filed: Jun. 16, 2006

Related U.S. Application Data
(60) Provisional application No. 60/693,695, filed on Jun. 24, 2005.

(51) Int. Cl. B67D 5/62

(52) U.S. Cl. 222/146.2

(57) ABSTRACT

A dispensing package with single use integral thermal engine for a product has an upper product tray having a product well for holding the product with a peelable lid removably attached to the upper product tray, covering the product contained in the product well. A lower base tray, having a thermal engine well, is attached to the bottom of the upper product tray. A thermal engine is contained within the thermal engine well. The thermal engine has an oxidizer pouch containing an oxidizing agent and fuel reactive to the oxidizing agent. Applying pressure to the oxidizer pouch causes the oxidizer pouch to rupture or burst thus dispensing the oxidizing agent into the thermal engine well mixing with the fuel and reacting to generate heat.

### CROSS REFERENCES TO RELATED APPLICATIONS

This application claims the benefit under 35 U.S.C. 119(e) of U.S. Provisional Application Ser. No. 60/693,695, entitled Product Dispensing Package With Single Use Integral Thermal Engine, filed on Jun. 24, 2005, and of U.S. Provisional Application Ser. No. 60/______, entitled Product Dispensing Package With Single Use Thermal Engine, filed on Jun. 15, 2006.

### FIELD OF INVENTION

The present invention relates disposable packaging and more particularly to heating and cooling of disposable packaging.

### BACKGROUND OF THE INVENTION

Many products are more effective when heated or cooled. Such products include but not limited to: skin care masks; hair treatment for the scalp; hot oil treatment for hair; depilatory creams, gels and liquids; hair removal creams, gels and liquids; muscle salves, creams, gels and liquids; tension cream, gels and liquids; relaxation creams, gels and liquids; headaches and neck tensions treatments; shave creams and gels; facial and skin creams, gels and liquids; cleansers; exfoliators; spa kits (for home); wax application formulas; shoe polish; hot pads, towels and sponges; vitamin treatments; medical topical creams, gels and liquids; insect sting treatments; and others.

A frequent problem is how to conveniently and safely heat or cool the products in small single use quantities. Traditionally this is accomplished by placing the product in hot water or in ice water. Unfortunately little uniformity in temperature is provided as this method is highly dependent on the temperature of the liquid and the duration of time it is kept there. It is extremely difficult to provide the warming or cooling of the products on demand.

Therefore there is a need for a single use package with an integral thermal engine for heating or cooling the product content.

### SUMMARY OF THE INVENTION

A dispensing package with single use integral thermal engine for a product has an upper product tray having a product well for holding the product with a peelable lid removably attached to the upper product tray, covering the product contained in the product well. A lower base tray, having a thermal engine well, is attached to the bottom of the upper product tray. A thermal engine is contained within the thermal engine well. The thermal engine has an oxidizer pouch containing an oxidizing agent and fuel reactive to the oxidizing agent. Applying pressure to the oxidizer pouch causes the oxidizer pouch to rupture or burst thus dispensing the oxidizing agent into the thermal engine well mixing with the fuel and reacting to generate heat. In another embodiment the thermal engine cools the product.

### BRIEF DESCRIPTION OF THE DRAWINGS

A more complete understanding of the present invention may be obtained from consideration of the following description in conjunction with the drawings in which:

FIG. 1 is an exploded perspective drawing of the present invention with side by side chambers;

FIG. 2 is an exploded perspective drawing of the present invention with stacked chambers;

FIGS. 3a, 3b, 3c & 3d are further views of the present invention with stacked chambers; and,

FIG. 4 is an illustration of the continuous strip manufacturing of the oxidizer pouch.

### DETAILED DESCRIPTION OF VARIOUS ILLUSTRATIVE EMBODIMENTS

The present invention, product dispensing package with single use integral thermal engine, is a package with an upper chamber for holding a product and a lower chamber for holding a thermal engine to heat or cool the product prior to application contains a material. The upper chamber holds a liquid, gel, or solid product and is sealed. The lower chamber holds a thermal engine which heats or cools the sealed product prior to application. The seal can be easily pealed open to give access to the heated or cooled product. An optional applicator can be included external to the package or can be provided in a divided portion of the upper chamber.

The present invention, dispensing package with single use integral thermal engine for a product has an upper product tray having a product well for holding the product with a peelable lid removably attached to the upper product tray, covering the product contained in the product well. A lower base tray, having a thermal engine well, is attached to the bottom of the upper product tray. A thermal engine is contained within the thermal engine well. The thermal engine has an oxidizer pouch containing an oxidizing agent and fuel reactive to the oxidizing agent. Applying pressure to the oxidizer pouch causes the oxidizer pouch to rupture or burst thus dispensing the oxidizing agent into the thermal engine well mixing with the fuel and reacting to generate heat.

Many products are more effective when heated or cooled, including but not limited to the following: skin care masks; hair treatment for the scalp; hot oil treatment for hair; depilatory creams, gels and liquids; hair removal creams, gels and liquids; muscle salves, creams, gels and liquids; tension cream, gels and liquids; relaxation creams, gels and liquids; headaches and neck tensions treatments; shave creams and gels; facial and skin creams, gels and liquids; cleansers; exfoliators; spa kits (for home); wax application formulas; shoe polish; hot pads, towels and sponges; vitamin treatments; medical topical creams, gels and liquids; insect sting treatments; and others.

The present invention, product dispensing package with single use integral thermal engine, is suitable for providing samples of various products as well as being used for bulk single use applications.

The present invention, product dispensing package with single use integral thermal engine, has small amounts (single use quantity) of a cream, liquid, gel or solid which is stored and dispensed from an upper chamber receptacle after heating or cooling. A brush may be placed in a recess for application or an external applicator such as a finger, tissue, brush, etc. can be used.

The present invention, product dispensing package with single use integral thermal engine device makes it possible to safely and conveniently store, heat or cool and dispense a product. The device is activated by pressure being exerted on the package, whereby the heating or cooling engine is activated. Exemplary thermal engines are described herein, although other thermal engines are equally well suited for use in the present invention. The mixing of two substances takes place in the lower chamber, activating the thermal engine which in turn heats or cools the contents of the upper chamber.

For this purpose, lower chamber of the device is plastically deformable. The chambers are preformed. The term “pre-formed” in the sense of the invention is to be understood as meaning a plastic, defined deforming or pre-forming of a film, it being possible for the film to be converted from this form into another form in a controlled and deliberate manner. This includes pre-forming both by peelable sealing with another film and seal-free zones. Pre-forming can be achieved, for example, by thermoforming a film by means of thermoforming molds.

Films in the sense of the invention are deformable, in particular plastically deformable, if, when they are exposed to an external force (for example by an internal pressure building up in a chamber when the device is activated), they yield to this force while deforming, for example by permanent expansion. Suitable films which can be deformed by the activation of the device preferably do not have any appreciable elasticity and consequently have no appreciable recovery.

A film is expandable in the sense of the invention if it can be permanently expanded or deformed by the internal pressure building up when the device is activated.

Furthermore, the substances can be filled into the chambers of the device with virtually no inclusion of atmospheric oxygen or other gases in the dead volume.

In one embodiment the present invention, product dispensing package with single use integral thermal engine can be used to directly apply a material, such as a cooled sting treatment for a bug bite, and may contain an optional adhesive that is exposed by the removal of the film covering the upper chamber.

The covering film is firstly thermoformed and subsequently inverted, so that the indentation in the film is located on the side opposite from the thermoformed mold. The thermal engine is then installed into the lower chamber and the upper chamber is placed so as to cover the lower chamber containing the thermal engine. The upper chamber is then filled and a cover film applied and sealed onto the lower films. Depending on the embodiment and films used, slight changes in geometry of the device may occur.

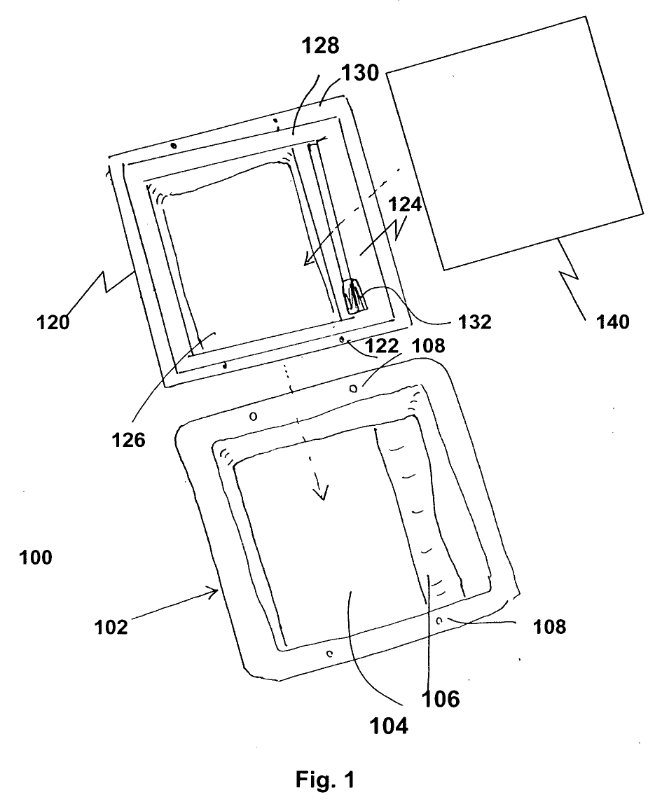

Referring to FIG. 1 there is shown an exploded perspective drawing of the present invention product dispensing package with single use integral thermal engine wherein the thermal engine has side by side fuel component chambers. The product dispensing package with single use integral thermal engine 100 is comprised of a base tray 102, which may be optionally insulated on the bottom. The base tray 102 contains the thermal engine within a well 104. The well 104 has an oxidizer pouch 106 which is used to separate the oxidizer from the fuel that is also in the well 104. Pressing or squeezing the oxidizer pouch 106 containing an oxidizing agent causing the oxidizer pouch 106 to rupture or burst thus dispensing the oxidizing agent into the well 104 of the base tray 102 mixing with the fuel contained therein, thus reacting and generating heat which warms the product. Alignment dimples 108 are used to accurately and rapidly align the base tray with alignment dimples 122 on a product tray 120. The product tray 120 has a product material well 126, a lip 128 which may have an optional adhesive for application. A product applicator well 124 contains an applicator 132 which may be sterile. A peelable foil or film lid 140 covers the product tray 120 and is attached by a seal edge 130.

The device is usually a disposable pack (unit dose). The device is suitable for storing and dispensing all substances for which reproducible mixing and apportioning, to a great extent independently of the user, is required. In particular, the device is useful in the cosmetic industry as well as in the area of human and veterinary medicine.

The film constituents may be chosen from plastic films, metal foils and ceramic sheets. Conceivable as plastic films are, for example: PE, PP, PTFE, PET, PA, PBT, PVC, EVA, PVF (polyvinyl fluoride) as well as others known to those skilled in the art.

Metal foils include but are not limited to the following: Al, Sn, Au, Ag, Fe, Pb. A film construction with the sequence from the outside inward of PET, Al, PET, PE or PP, Al, PET, PE, if appropriate also without a PET film as a middle film. Other sequences are equally well suited and known to those skilled in the art.

The connection of the films may take place, for example, by hot-sealing, cold-sealing, adhesive bonding and/or ultrasonic welding with sonotrodes. A multilayer construction of films can be achieved by laminating, calendering, laminating of various layers comprising single films, if appropriate also by vapor-depositing, for example with metals.

To ensure that the substances which are introduced into the device and can be applied are protected from incident light, films are selected to be opaque or UV blocking as necessary.

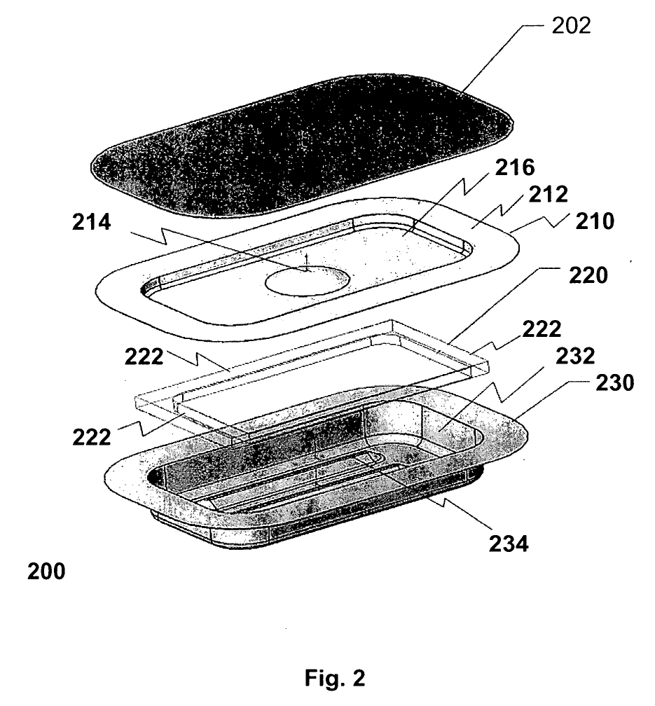

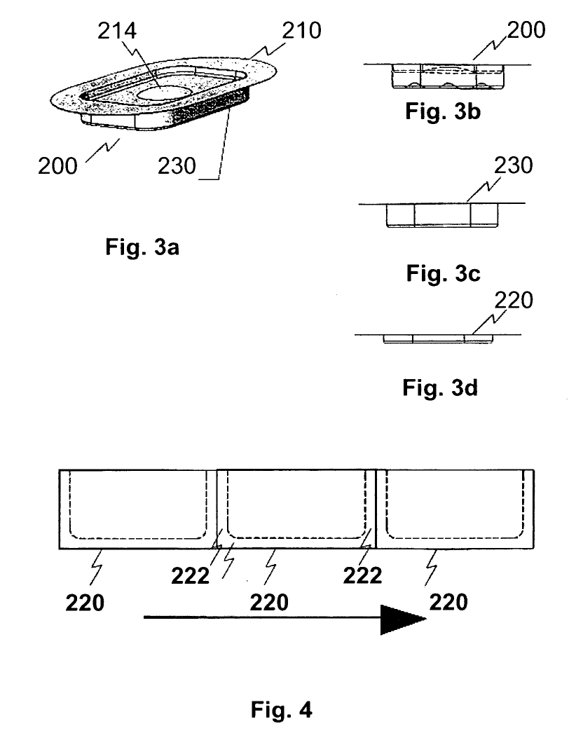

Referring to FIGS. 2, 3a, 3b, 3c, and 3d together there is shown an exploded perspective view of the present invention with stacked fuel cell chambers 200 as well as other views. In particular FIGS. 2, 3a, 3b, 3c, and 3d together show a product cover lid 202, product tray 210, oxidizer pouch 220 and base tray 230. The product tray has a lip 212 to which the product cover lid 202 is sealed, a raise push bubble 214 which deforms when pressed enabling the oxidizer pouch 220 to be ruptured, and a product well 216. The oxidizer pouch 220 is sealed on three edges 222. The base tray 230 has a thermal engine well 232 with raised ridges 234 within the thermal engine well 232.

In an exemplary embodiment the product cover lid 202 is a laminate of a 2 mil peelable coex film, layered with 3.25 grams/m² adhesive/EAA, layered with 0.0003 aluminum, layered with 3.25 grams/m² adhesive/White LDPE, with a top layer of 48 gauge polyester which is printed with an indicia suitable for the product contents and/or related to a promotional use or giveaway.

An exemplary embodiment of the product tray 210 is a laminate of a 2 mil LLD Polyetheylene, layered with 2.5 grams/m² adhesive, with 5 mil PETG White, layered with 2.5 grams/m² adhesive, with a top layer of 2 mil LDD Polyethelene which is optionally printed with an indicia suitable for the product contents.

In an exemplary embodiment the oxidizer pouch 220 is 48 gauge PET-850h-80 Melinex which is a 3 sided seal on edge 222, manufactured vertically. In an exemplary embodiment the base tray 230 is a laminate of 50u PE layered with 2.5 grams/m² adhesive, and a top layer of PETG 350u white.

The base tray 230 has ridges providing stability and raising the fuel cell reaction area partially away from the bottom. By pressing on the raised push bubble 214 at the center of the product tray 210, pressure is applied to the oxidizer pouch 220 containing an oxidizing agent causing the oxidizer pouch 220 to rupture or burst thus dispensing the oxidizing agent 224 into the thermal engine well 232 mixing with the fuel contained therein, thus reacting and generating heat.

In an alternate embodiment the base tray 230 contains the oxidizing agent while the fuel is contained in a pouch. Pressure is applied to an inner pouch containing a fuel causing the pouch to rupture or burst thus dispensing fuel into the thermal engine well mixing with the oxidizing agent contained therein, thus reacting and generating heat.

By employing compact packaging for the fuel cell, and thus being able to have the oxidizing agent and the corresponding fuel mix in the thermal engine well 232 of the base tray 230, the present invention provides uniform heating of the product.

In yet a further embodiment, both the oxidizing agent and the fuel are contained in individual pouches. Pressure is applied to inner pouches containing separately a fuel and an oxidizing agent, causing the pouches to rupture or burst thus dispensing fuel and the oxidizing agent into the thermal engine well 232 of the base tray 230, thus mixing and reacting to generate heat.

Referring to FIG. 4 there is shown an illustration of the continuous strip manufacturing of the oxidizer pouch 220 is sealed on three edges 222 to contain the oxidizing agent 224.

There are many types of thermal engines, including fuel cells that are known to those skilled in the art. While some relevant information relating to exemplary thermal engines is described herein, it is not to be considered comprehensive or limiting in any way.

Portable heating and cooling devices are known. Compact, self-heating devices that produce heat through exothermic chemical reactions are known. For example, U.S. Pat. No. 4,397,315, which in incorporated herein by reference, discloses a device having an outer envelope and an inner envelope, with the outer envelope containing sodium thiosulfate, and the inner envelope containing ethylene glycol. The walls of the inner envelope are rupturable, allowing the contents of each envelope to mix. U.S. Pat. No. 5,035,230, which in incorporated herein by reference, discloses a heat pack having two compartments separated by a frangible seal. Potassium permanganate oxidizing agent coated with sodium silicate is provided in one zone of the heat pack, and aqueous ethylene glycol fuel is provided in the other zone. In operation of the device, a seal between the two zones is compromised to allow the reactants to come in contact with each other. U.S. Pat. No. 6,116,231, which in incorporated herein by reference, discloses another heat pack having two compartments separated by a frangible seal, in which gelling agent is employed to assist in the regulation of heat evolution in the heat pack. U.S. Pat. No. 5,984,953, which in incorporated herein by reference, discloses another heat pack having two compartments in which a stifffenable gel is employed, along with the evaporation and reversible removal of solvent from the gel to assist in the regulation of heat evolution in the heat pack.

Devices for producing heat or cold by heat of dilution rather than by chemical reaction are also known. U.S. Pat. No. 3,804,077, which in incorporated herein by reference, describes a heat pack which contains a water soluble chemical (e.g., calcium chloride) and a starch material acting as a gelling agent in one zone, and water in another zone.

Devices for producing cold by mixing of materials are also known. U.S. Pat. No. 6,099,555, which in incorporated herein by reference, for example, describes a cold pack having two compartments separated by a frangible seal, in which gelling agent is employed to assist in the regulation of cold evolution in the cold pack.

A self-contained device for heating material and dispensing the heated material includes at least one activatable heat-generating element, and at least one container for containing material to be heated by the heat-generating element. The container is in thermal contact with the heat-generating element, and the container includes an openable seal, which can be a repeatably openable seal. The material to be heated can be contained within the device prior to activation of the heat-generating element. The container can be made of, for example, polyethylene, polypropylene, polyester, metal foil, metallized plastic film, rubber, vinyl, or vinyl-coated fabric. The heat-generating element can include a heat pack providing heat through an exothermic chemical reaction, such as a reduction-oxidation reaction. The heat pack can include an oxidizing agent, a fuel, and a solvent, with the oxidizing agent and fuel separated by a frangible seal. The heat pack can also include a gelling agent, which can, for example, form a gel upon activation of the heat pack. The heat pack can also include a phase-change material. The heat pack itself can include an envelope made of, for example, polyethylene, polypropylene, polyester, metal foil, metallized plastic film, rubber, vinyl, or vinyl-coated fabric. The device can be made able to stand upright, for example by the use of gussets.

Separators and gelling agents suitable for use in heat packs to be employed in the present device are described in U.S. Pat. No. 6,116,231, entitled “Liquid Heat Pack,” and U.S. Pat. No. 5,984,953 entitled “Self-Regulating Heat Pack” each of which is hereby incorporated by reference in its entirety. For example, in particular embodiments, the fuel and oxidizing agent come into contact with one another by opening, selectively perforating, rupturing or otherwise compromising the separator between the zones.

Cold-producing elements include a cold pack which provides cold through an interaction between particular reactants, located in physically separated zones, or compartments, containing reactants. The cold pack includes two types of zones. Cold packs which can usefully be employed in the present device are described in U.S. Pat. No. 6,099,555 entitled “Gelling Cold Pack,” which is hereby incorporated by reference in its entirety. For example, in particular embodiments, cold packs can employ reactants which produce cold through endothermic reactions, or those which exhibit a negative heat of reaction. For example, the dissolution in water of inorganic salts such as ammonium nitrate, potassium nitrate, ammonium sulfate, and ammonium chloride produce cold. Further useful cold-generating materials are organic materials such as urea, and other inorganic salts such as ammonium bromide, ammonium iodide, potassium chloride, tin chloride dihydrate, diamminecobalt, dichlorocobalt hexahydrate, and nickel nitrate hexahydrate.

The material with which the cold-generating material interacts is a liquid. The liquid can be aqueous, that is water, or water containing other components, such as hydroxylic and polyhydroxylic species such as alcohols, glycerol, ethylene glycol, propylene glycol and similar compounds. Additional components of the gelling cold packs of the invention can be, for example, phase change materials.

Gelling agents can also be employed in cold packs, and are either organic or inorganic. Inorganic compounds such as metal oxides, metal alkoxides, or alkali metal salts of metal oxides can be used. These include zinc oxide, tin oxide, titanium oxide, zirconium oxide, and silicates and aluminates in combination with solvents such as water and alcohols. Useful organic gelling agents include organic compounds such as carbohydrates including starch; polyacrylamide; polyols such as pentaerythritol; or proteinaceous materials such as dried gelatin. These agents can form gels in combination with solvents such as water, acetone, alcohols, dimethoxytetraglycol. Many further examples of organic- and inorganic-based gel systems are known to those skilled in the art.

The cold packs may optionally contain additional constituents. Among these are phase change materials. Phase change materials store or release latent heat upon a change of phase from a solid phase to a liquid phase, from one solid phase to another solid phase, or vice versa.

U.S. Pat. No. 6,640,801, which in incorporated herein by reference, discloses a disposable heating device that includes a container having a first zone, a second zone and a third zone. A fuel is contained within the first zone and an oxidizing agent contained within the second zone. A first frangible separator disposed between the first zone and the second zone. The first frangible separator is manually operable to provide communication between the first zone and the second zone thereby defining a reaction zone. A second frangible separator is responsive to an exothermic chemical reaction within the reaction chamber. The second frangible separator is operable to provide communication between the reaction chamber and the third zone. Communication between the first zone and the second zone allows mixing of the fuel and the oxidizing agent to initiate an exothermic chemical reaction and an environmental parameter associated with the exothermic chemical reaction operates the second frangible separator.

U.S. Pat. No. 6,099,555, which in incorporated herein by reference, discloses a cold pack which utilizes the negative heat of solution of a material dissolving in a liquid. The cold pack further includes a gelling agent, which is activatable to form a gel. The gel provides a number of benefits, including better distribution of cold, increased cold persistence in the cold pack, and a more complete utilization of the ingredients of the cold pack than possible with prior art devices.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claims, is reserved.

What is claimed:

1. A dispensing package with single use integral thermal engine for a product, the dispensing package comprising:
an upper product tray having a product well for holding the product;
a peelable lid removably attached to the upper product tray thereby covering the product contained in the product well;
a lower base tray having a thermal engine well, the lower base tray attached to the bottom of the upper product tray;
a thermal engine contained within the thermal engine well;
the thermal engine comprising; an oxidizer pouch containing an oxidizing agent; and fuel reactive to the oxidizing agent;
wherein by applying pressure to the oxidizer pouch causes the oxidizer pouch to rupture or burst thus dispensing the oxidizing agent into the thermal engine well mixing with the fuel and reacting to generate heat;
whereby the product contained in the product well is warmed.

2. The dispensing package with single use integral thermal engine for a product as recited in claim 1 wherein the lower base tray has a plurality of ridges.

3. The dispensing package with single use integral thermal engine for a product as recited in claim 2 wherein at least some of the plurality of ridges extend into the thermal engine well.

4. The dispensing package with single use integral thermal engine for a product as recited in claim 1 wherein the upper product tray has a deformable bubble to enable rupture or bursting of the oxidizer pouch when pressure is applied.

5. The dispensing package with single use integral thermal engine for a product as recited in claim 1 wherein the oxidizer pouch is Melinex.

6. The dispensing package with single use integral thermal engine for a product as recited in claim 1 wherein the oxidizer pouch is sealed on three sides.

7. The dispensing package with single use integral thermal engine for a product as recited in claim 1 wherein the lower base tray is a laminate.

8. The dispensing package with single use integral thermal engine for a product as recited in claim 1 wherein the upper product tray is a laminate.

9. The dispensing package with single use integral thermal engine for a product as recited in claim 1 wherein the peelable lid is a coex film.

10. The dispensing package with single use integral thermal engine for a product as recited in claim 1 wherein the upper product tray has a product applicator well.

11. The dispensing package with single use integral thermal engine for a product as recited in claim 1 wherein the peelable lid is a laminate of a 2 mil peelable coex film, layered with 3.25 grams/m² adhesive/EAA, layered with 0.0003 aluminum, layered with 3.25 grams/m adhesive/White LDPE, with a top layer of 48 gauge polyester.

12. The dispensing package with single use integral thermal engine for a product as recited in claim 1 wherein the peelable lid contains an indicia suitable for promotional use.

13. The dispensing package with single use integral thermal engine for a product as recited in claim 1 wherein the upper product tray is a laminate of a 2 mil LLD Polyetheylene, layered with 2.5 grams/m² adhesive, with 5 mil PETG White, layered with 2.5 grams/m² adhesive, with a top layer of 2 mil LDD Polyethelene.

14. The dispensing package with single use integral thermal engine for a product as recited in claim 1 wherein the oxidizer pouch 220 is 48 gauge PET-850h-80 Melinex.

15. The dispensing package with single use integral thermal engine for a product as recited in claim 1 wherein the oxidizer pouch is a 3 sided seal on edge.

16. The dispensing package with single use integral thermal engine for a product as recited in claim 1 wherein the base tray 230 is a laminate of 50u PE layered with 2.5 grams/m² adhesive, and a top layer of PETG 350u white.

17. The dispensing package with single use integral thermal engine for a product as recited in claim 1 wherein the oxidizer pouch defines a horizontal layer at the top of the thermal engine well.

18. The dispensing package with single use integral thermal engine for a product as recited in claim 1 wherein the oxidizer pouch is positioned at the bottom of the thermal engine well.

19. The dispensing package with single use integral thermal engine for a product as recited in claim 1 wherein the upper product tray further comprises an adhesive.

20. The dispensing package with single use integral thermal engine for a product as recited in claim 1 wherein the oxidizer pouch is comprised of a plurality of pouches.
